(19) United States
(12) Patent Application Publication
(10) Pub. No.: US 2019/0248195 A1
(43) Pub. Date: Aug. 15, 2019

(54) QUICK CONNECT TIRE TRACTION DEVICE

(71) Applicant: EZAS, LLC, Falls Church, VA (US)

(72) Inventor: Michael D. Curry, Falls Church, VA (US)

(21) Appl. No.: 16/273,974

(22) Filed: Feb. 12, 2019

Related U.S. Application Data
(60) Provisional application No. 62/629,426, filed on Feb. 12, 2018.

(51) Int. Cl. B60C 27/02; B60C 27/04

(52) U.S. Cl. CPC B60C 27/0276; B60C 27/023; B60C 2200/06; B60C 27/04; B60C 27/0246

(57) ABSTRACT

A quick connect tire traction system for providing traction to a tire on a vehicle wheel. The quick connect tire traction system includes an expansion strap coupled to one or more tire traction devices, an inner support coupled to the expansion strap with a rotation member, an outer extension telescopically coupled to the inner support, a rim mount coupled to the outer extension, the rim mount configured to receive one or more locking pins, and an elastic element extending between the inner support and the outer extension. The elastic element is adapted to bias the tire traction devices toward the rim mount thereby securing the quick connect tire traction system to the tire. A method of installing the quick connect tire traction system on a tire.

### CROSS-REFERENCE TO RELATED APPLICATION

This application claims priority to U.S. Provisional Application No. 62/629,426 filed Feb. 12, 2018, the entire content of which is hereby incorporated by reference.

### TECHNICAL FIELD

The present application relates generally to apparatuses and methods usable to connect a tire traction device to vehicle wheels. More specifically, the present application relates to apparatuses that can be quickly connected to vehicle wheels to improve the traction of the tires.

### BACKGROUND

Vehicles can occasionally get stuck or go off road, for example, when travelling on muddy, snowy, icy, or sandy road conditions. Often times, it is necessary for a tow truck, hauler, or other rescue vehicle to assist the stuck vehicle. This is especially true in the case of heavy commercial vehicles such as tractor trailers. Tire-mounted devices, such as chains, have been developed to improve tire traction in emergency situations. However, known tire-mounted devices can be difficult to install, and/or provide insufficient traction to assist heavy vehicles in becoming unstuck without outside vehicular assistance. Thus, a need exists for an apparatus and system to quickly connect a tire traction device to vehicle wheels.

### SUMMARY

According to an embodiment, a quick connect tire traction system for providing traction to a tire on a vehicle wheel may include an expansion strap coupled to one or more tire traction devices; an inner support coupled to the expansion strap with a rotation member; an outer extension telescopically coupled to the inner support; a rim mount coupled to the outer extension, the rim mount configured to receive one or more locking pins; and an elastic element extending between the inner support and the outer extension. The elastic element is adapted to bias the tire traction devices toward the rim mount thereby securing the quick connect tire traction system to the tire.

According to an embodiment a method for installing a tire traction device on a tire of a vehicle wheel may include coupling an expansion strap to one or more tire traction devices; inserting a rim mount into a space between a first tire and a second tire, the rim mount coupled to the expansion strap by an elastic member; resting a lower surface of the one or more tire traction devices on an exterior surface of the first and second tires; extending a locking pin through an opening in a first rim mounting the first tire, through an opening in the rim mount, and through an opening in a second rim mounting the second tire; and extending the elastic member to secure the one or more tire traction devices to the first tire and the second tire.

### BRIEF DESCRIPTION OF THE DRAWINGS

The foregoing aspects and other features and advantages of the invention will be apparent from the following drawings, wherein like reference numbers generally indicate identical, functionally similar, and/or structurally similar elements.

FIG. 1 is a perspective view of a quick connect tire traction device, according to an embodiment.

FIG. 2 is an exploded view of the quick connect tire traction device of FIG. 1, according to an embodiment.

FIG. 3A is a bottom view of an outer extension of the quick connect tire traction device of FIG. 1, according to an embodiment.

FIG. 3B is a side view of the outer extension of FIG. 3A, according to an embodiment.

FIG. 3C is another side view of the outer extension of FIG. 3A, according to an embodiment.

FIG. 4A is a perspective view of an inner support of the quick connect tire traction device of FIG. 1, according to an embodiment.

FIG. 4B is a top view of the inner support of FIG. 4A, according to an embodiment.

FIG. 4C is a bottom view of the inner support of FIG. 4A, according to an embodiment.

FIG. 4D is a side view of the inner support of FIG. 4A, according to an embodiment.

FIG. 4E is another side view of the inner support of FIG. 4A, according to an embodiment.

FIG. 5 is a perspective view of a quick connect tire traction device, according to an embodiment.

FIG. 6 is an exploded view of the quick connect tire traction device of FIG. 5, according to an embodiment.

FIG. 7A is a top view of an outer extension of the quick connect tire traction device of FIG. 5, according to an embodiment.

FIG. 7B is a side view of the outer extension of FIG. 7A, according to an embodiment.

FIG. 7C is another side view of the outer extension of FIG. 7A, according to an embodiment.

FIG. 8A is a perspective view of an inner support of the quick connect tire traction device of FIG. 5, according to an embodiment.

FIG. 8B is a top view of the inner support of FIG. 8A, according to an embodiment.

FIG. 8C is a bottom view of the inner support of FIG. 8A, according to an embodiment.

FIG. 8D is a side view of the inner support of FIG. 8A, according to an embodiment.

FIG. 8E is another side view of the inner support of FIG. 8A, according to an embodiment.

FIG. 9 is a perspective view of an exemplary tire traction device, according to an embodiment.

FIG. 10 is a perspective view of an expansion strap of a quick connect tire traction device, according to an embodiment.

FIG. 11A is a perspective view of a center mount of a quick connect tire traction device, according to an embodiment.

FIG. 11B is a bottom view of the center mount of FIG. 11A, according to an embodiment.

FIG. 11C is a front view of the center mount of FIG. 11A, according to an embodiment.

FIG. 11D is a side view of the center mount of FIG. 11A, according to an embodiment.

FIG. 12A is a perspective view of a rim mount of a quick connect tire traction device, according to an embodiment.

FIG. 12B is a bottom view of the rim mount of FIG. 12A, according to an embodiment.

FIG. 12C is a front view of the rim mount of FIG. 12A, according to an embodiment.

FIG. 13A is a side view of a locking pin of a quick connect tire traction device, according to an embodiment.

FIG. 13B is a side view of the locking pin of FIG. 13A, rotated 90 degrees from the view of FIG. 13A, according to an embodiment.

FIG. 14 is a perspective view of a quick connect traction device being installed on a vehicle wheel, according to an embodiment.

FIG. 15 is a front-perspective view of a vehicle wheel showing the quick connect traction device of FIG. 14 being installed thereon, according to an embodiment.

FIG. 16 is a rear-perspective view of a vehicle wheel showing the quick connect traction device of FIG. 14 installed thereon, according to an embodiment.

FIG. 17 is a side view of a vehicle wheel having the quick connect traction device of FIG. 14 installed thereon, according to an embodiment.

### DE TAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without departing from the spirit and scope of the invention. Embodiments of the present invention relate to a quick connect tire traction device for attaching to a vehicle wheel. The quick connect tire traction device may include a rim mount coupled to one or more tire traction devices via an outer extension, center mount, and expansion strap. The rim mount may be coupled to a rim of the vehicle wheel with a locking pin extending through an opening in the rim mount. The quick connect tire traction device may allow for quick, easy installation by a single user. Once mounted, the quick connect tire traction device may securely couple the one or more tire traction devices to the vehicle wheel.

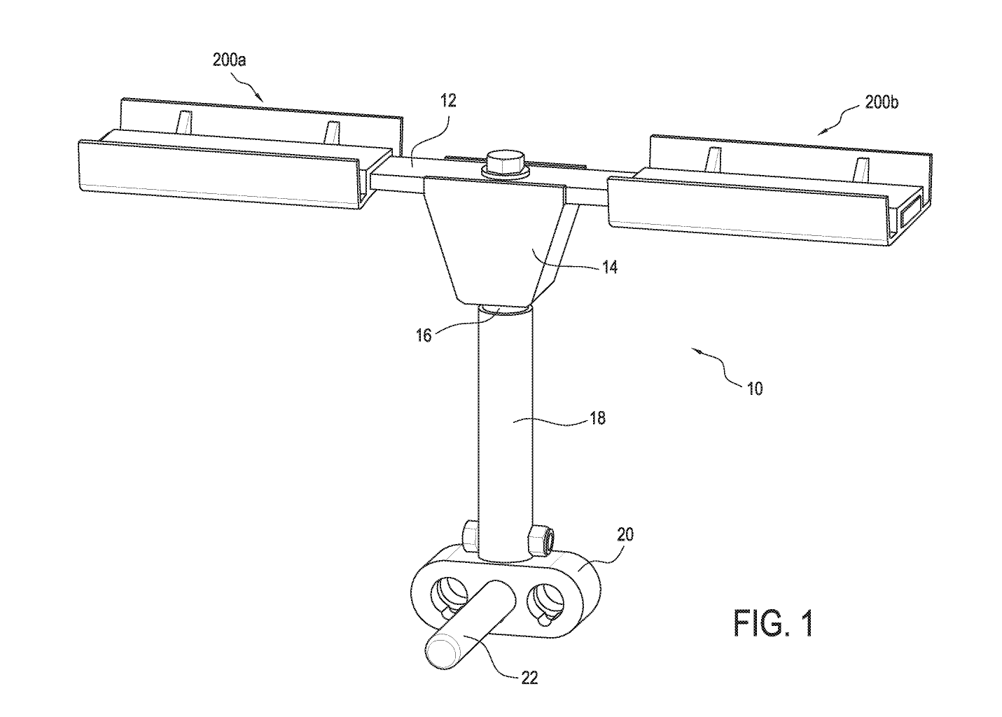

Referring to FIG. 1, a perspective view of a quick connect tire traction device 10 is shown. The quick connect tire traction device 10 may include an expansion strap 12 coupled to one or more tire traction devices, for example, a first device 200a and a second device 200b. The expansion strap 12 may be coupled to a center mount 14, an inner support 16, an outer extension 18, and a rim mount 20. The rim mount 20 may be coupled to a rim of a vehicle wheel with a locking pin 22 such that, when coupled, the tire traction devices 200 are firmly secured to the outer surface of the vehicle wheel, as will be explained in more detail.

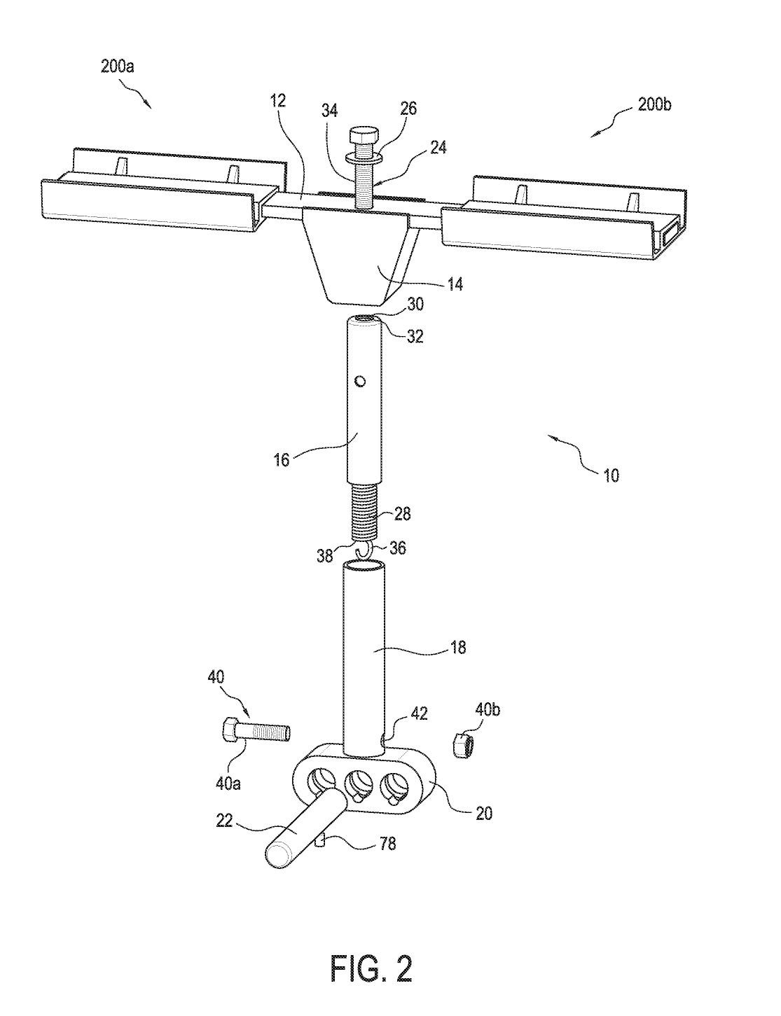

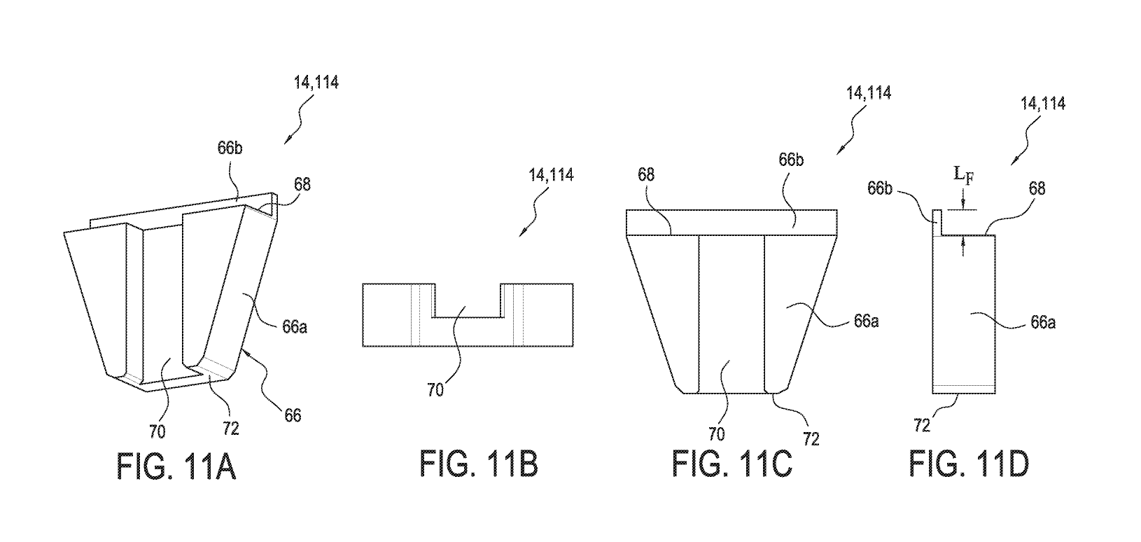

Referring to FIG. 2, an exploded view of the quick connect tire traction device 10 is shown. The center mount 14 may be welded or otherwise fastened to the expansion strap 12. The center mount 14 may be provided with an opening (as will be discussed in FIG. 11) through which the inner support 16 and a rotation member 24 may extend. The rotation member 24 may be a conventional hexagonal head fastener having a washer 26. Alternatively, the rotation member 24 may be any fastening member which may be rotated to effectuate compression of the spring 28, as will be described in more detail to follow.

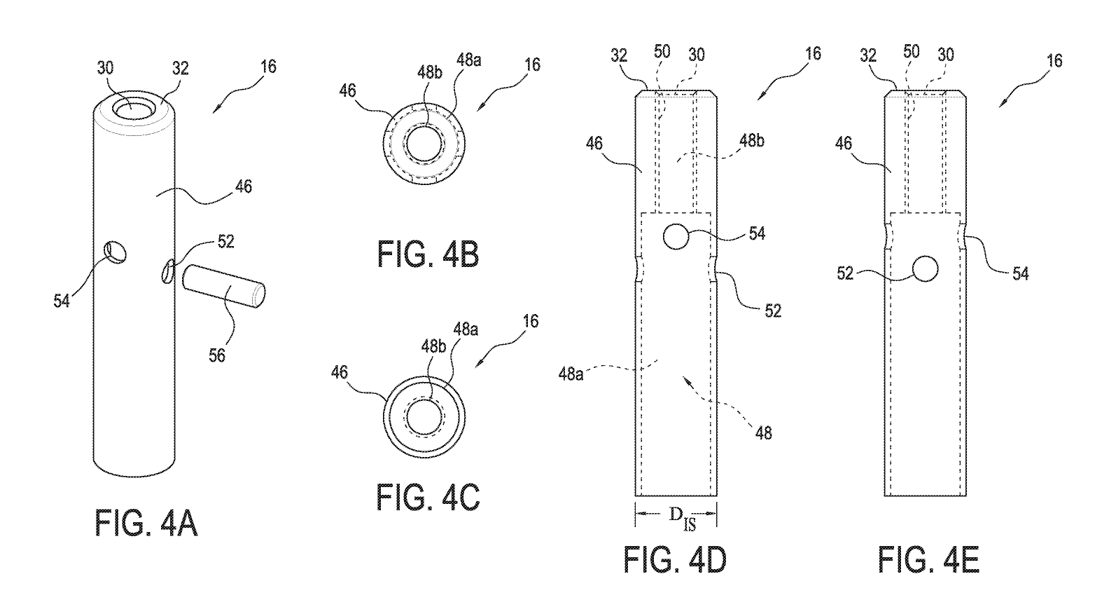

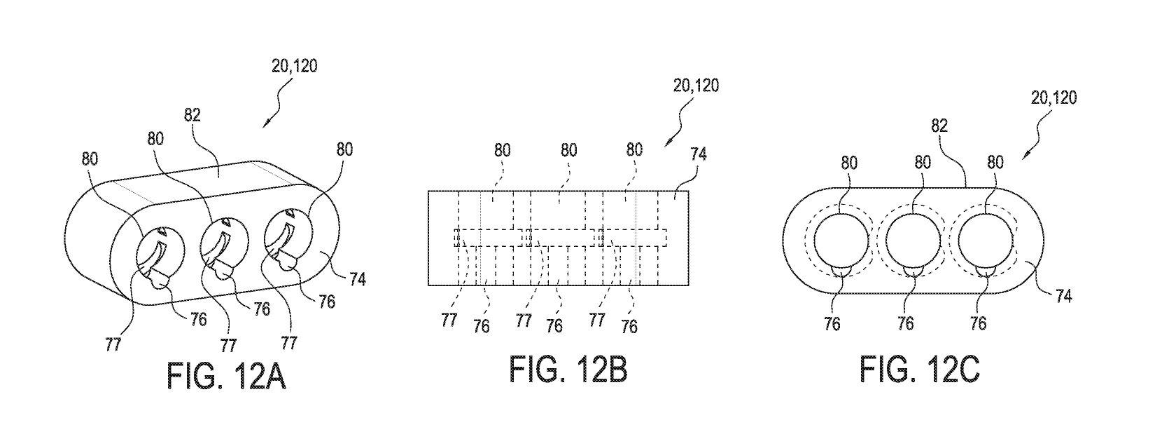

The rotation member 24 may extend through an opening 30 in a top surface 32 of the inner support 16. The rotation member 24 may include a threaded outer surface 34 which may interact with a threaded surface 50 (FIG. 4D) of the inner support 16. The inner support 16 may house the spring 28. The spring 28 may have a coupling member 36, such as a hook or loop, at a distal end 38. The spring 28 may have another coupling member, the same as or similar to coupling member 36, at the proximal end (not depicted). The spring 28 may be a coil spring, or other spring type. As an alternative to the spring 28, other elastic members known in the art, such as one or more elastic bands, may be used. The inner support 16 may have an outer diameter smaller than an inner diameter of the outer extension 18, such that the inner support 16 is housed within the outer extension 18. The outer extension 18 may be welded or otherwise fastened to the rim mount 20. The outer extension 18 may include a fastening member 40 extending through an opening 42. The fastening member 40 may be a screw having a threaded bolt portion 40a and a corresponding nut portion 40b. The fastening member 40 may extend through the opening 42 and through the coupling member 36 of the spring 28. The fastening member 40 may be tightened such that the spring 28 is coupled to the outer extension 18 and thus to the rim mount 20. The quick connect tire traction device 10 may further include one or more locking pins 22. Each of the one or more locking pins 22 may have a locating pin 78 secured thereto. The locking pin 22 may be inserted into an opening 80 (FIG. 12A) in the rim mount 20, as will be described in more detail to follow.

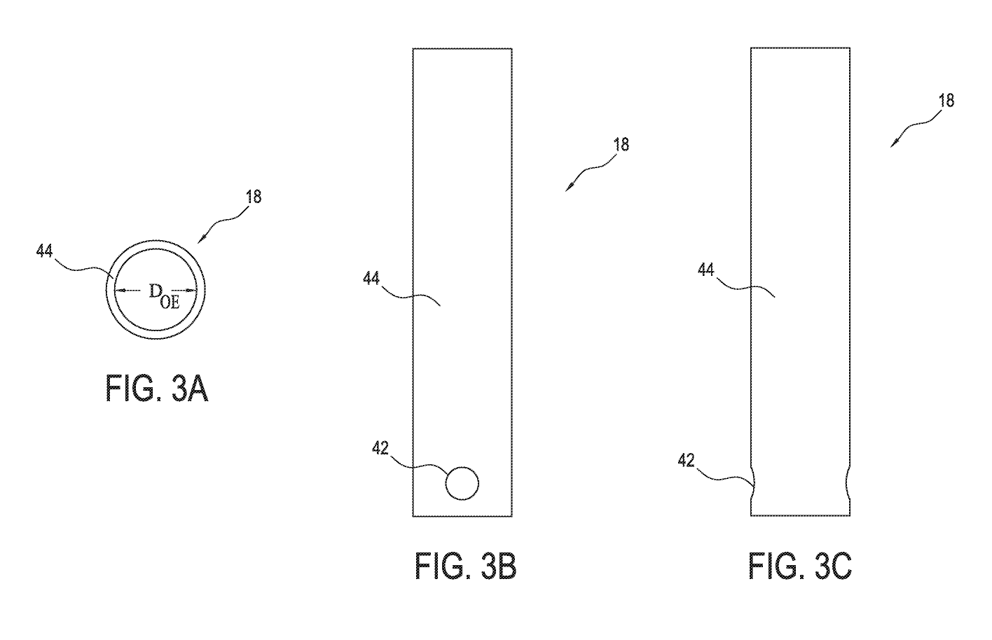

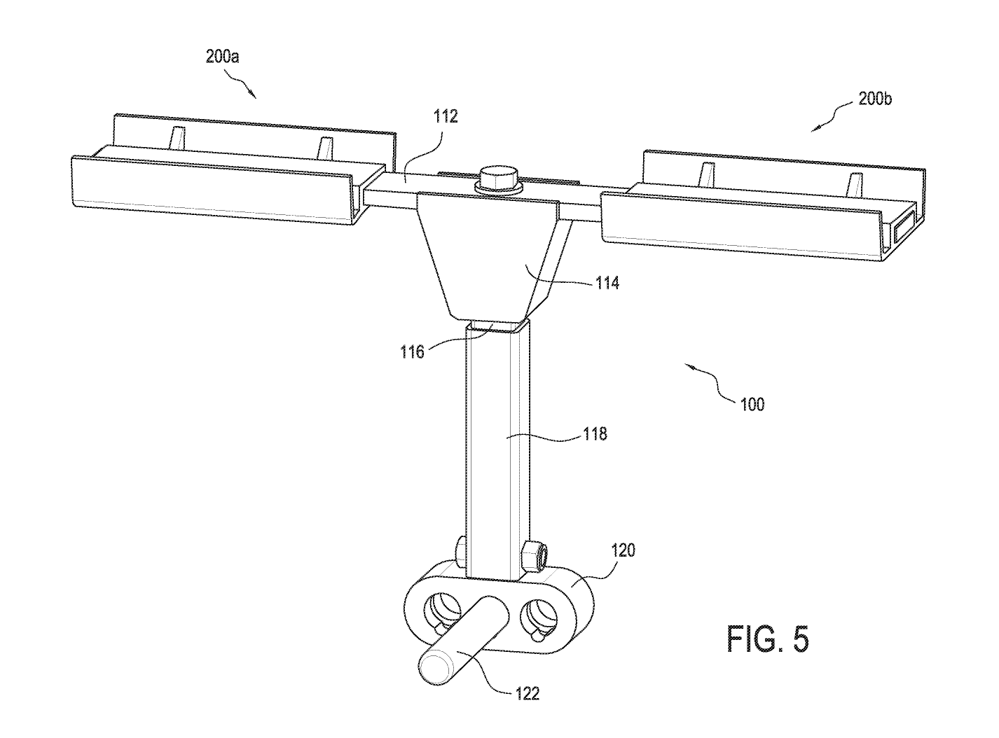

Referring now to FIGS. 3A-3C, the outer extension 18 is shown. The outer extension 18 may have a cylindrical body 44, although other shapes are contemplated, such as rectangular (FIGS. 5-8), triangular, polygonal, etc. The opening 42 may extend through opposing walls of the cylindrical body 44. The outer extension 18 may have an inner diameter D_{OE}. The inner diameter D_{OE} may be larger than an outer diameter D_{IS} (FIG. 4D) of the inner support 16. This may allow the outer extension 18 to house the inner support 16 within the cylindrical body 44, such that the inner support 16 can telescope within the outer extension 18. As may be appreciated from FIG. 1, when assembled, the inner support 16 may be substantially within the outer extension 18.

Referring now to FIGS. 4A-4E, the inner support 16 is shown. The inner support 16 may have a cylindrical body 46, although other shapes are contemplated, such as rectangular (FIGS. 5-8), triangular, polygonal, etc. The cylindrical body 46 may include a bore 48 having a first bore section 48a and a second bore section 48b. The first bore section 48a may have a larger diameter than the second bore section 48b. The first bore section 48a may extend along a longer length of the inner support 16 than the second bore section 48b. The second bore section 48b may include a threaded surface 50. The threaded surface 50 may interact with the threaded outer surface 34 of the rotation member 24.

With continued reference to FIGS. 4A, 4D, and 4E, the cylindrical body 46 may include an opening 52 and an opening 54. The opening 52 or opening 54 may accommodate a pin 56. The pin 56 may be inserted through the opening 52 or opening 54 and through a coupling member (similar to 36 of FIG. 2) on the proximal end of the spring 28 (FIG. 2). The pin 56 may be welded or otherwise secured in the opening 52 or the opening 54 such that spring 28 is securely fastened to the inner support 16. The opening 52 or opening 54 may be selected for the pin 56 based on the desired tension of the spring 28 and the desired permitted movement of the inner support 16 within the outer extension 18.

Referring now to FIG. 5, a perspective view of an alternative quick connect tire traction device 100 is shown. The quick connect tire traction device 100 may be the same or similar to the quick connect tire traction device 10 of FIG. 1, except that the inner support 116 and the outer extension 118 may be substantially rectangular or square in cross-section. The quick connect tire traction device 100 may include an expansion strap 112 coupled to one or more tire traction devices, for example, a first device 200a and a second device 200b. The expansion strap 112 may be coupled to a center mount 114, an inner support 116, an outer extension 118, and a rim mount 120. The rim mount 120 may be coupled to a rim of a vehicle tire with a locking pin 122 such that, when coupled, the tire traction devices 200 are firmly secured to the outer surface of the vehicle wheel, as will be explained in more detail.

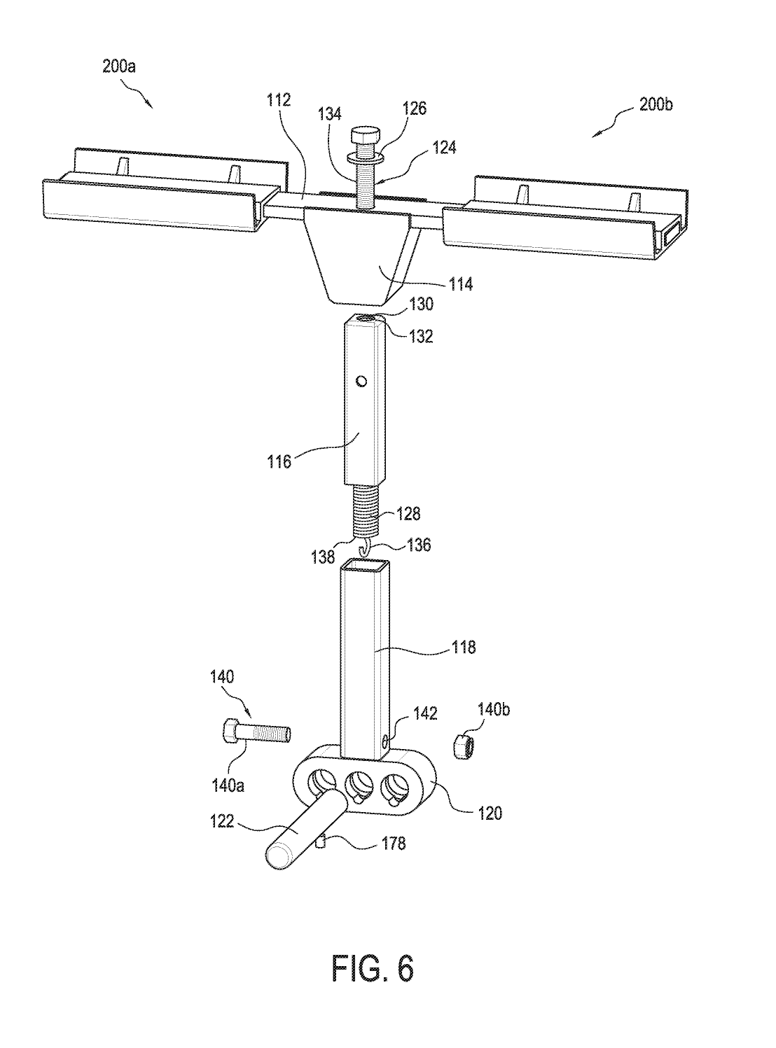

Referring to FIG. 6, an exploded view of the quick connect tire traction device 100 is shown. The center mount 114 may be welded or otherwise fastened to the expansion strap 112. The center mount 114 may be provided with an opening (as will be discussed in FIG. 11) through which the inner support 116 and a rotation member 124 may extend. The rotation member 124 may be a conventional hexagonal head fastener having a washer 126. Alternatively, the rotation member 124 may be any fastening member which may be rotated to effectuate compression of the spring 128, as will be described in more detail to follow.

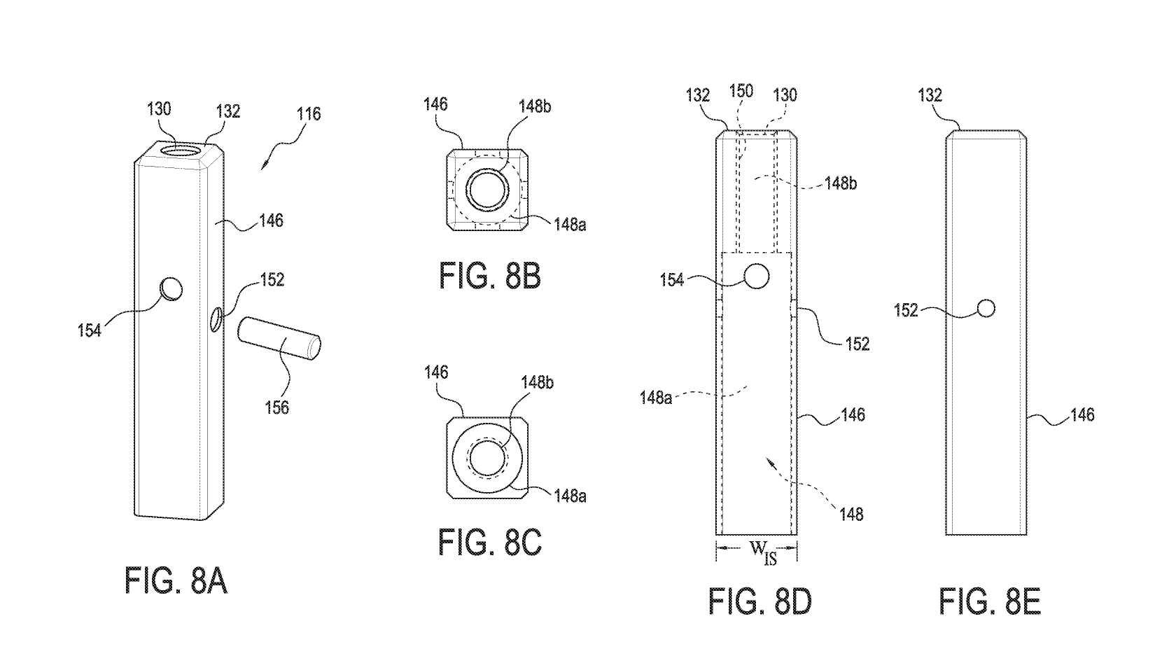

The rotation member 124 may extend through an opening 130 in a top surface 132 of the inner support 116. The rotation member 124 may include a threaded outer surface 134 which may interact with a threaded surface 150 (FIG. 8D) of the inner support 116. The inner support 116 may house the spring 128. The spring 128 may have a coupling member 136, such as a hook or loop, at a distal end 138. The spring 128 may have another coupling member, the same as or similar to coupling member 136, at the proximal end (not depicted). The spring 128 may be a coil spring, or other spring type. As an alternative to the spring 128, other elastic members known in the art, such as one or more elastic bands, may be used. The inner support 116 may have an outer dimension, such as a width, smaller than an inner dimension, such as a width, of the outer extension 118, such that the inner support 116 is housed within the outer extension 118. The outer extension 118 may be welded or otherwise fastened to the rim mount 120. The outer extension 118 may include a fastening member 140 extending through an opening 142. The fastening member 140 may be a screw having a threaded bolt portion 140a and a corresponding nut portion 140b. The fastening member 140 may extend through the opening 142 and through the coupling member 136 of the spring 128. The fastening member 140 may be tightened such that the spring 128 is coupled to the outer extension 118 and thus to the rim mount 120. The quick connect tire traction device 100 may further include one or more locking pins 122. Each of the one or more locking pins 122 may have a locating pin 178 secured thereto. The locking pin 122 may be inserted into an opening 80 (FIG. 12A) in the rim mount 120, as will be described in more detail to follow.

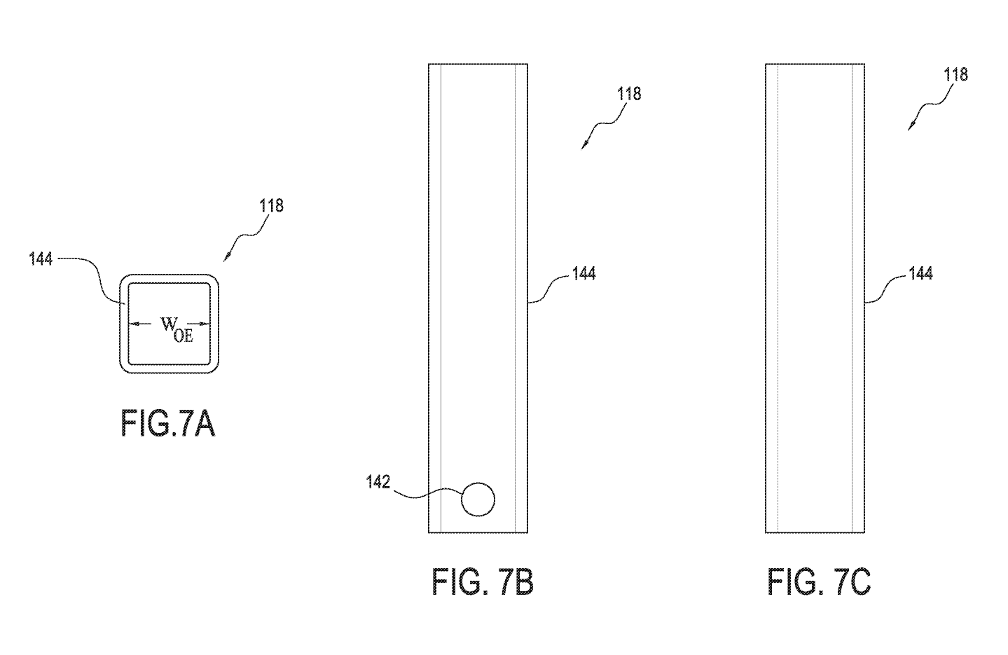

Referring now to FIGS. 7A-7C, the outer extension 118 is shown. The outer extension 118 may have a body 144 with a rectangular or square cross-section, although other shapes are contemplated, such as cylindrical (FIGS. 1-4), triangular, polygonal, etc. The opening 142 may extend through opposing walls of the body 144. The outer extension 118 may have an inner dimension W_{OE}. The inner dimension W_{OE} may be larger than an outer dimension W_{IS} (FIG. 8D) of the inner support 116. This may allow the outer extension 118 to house the inner support 116 within the body 144, such that the inner support 116 can telescope within the outer extension 118. As may be appreciated from FIG. 5, when assembled, the inner support 116 may be substantially within the outer extension 118.

It may be appreciated in FIGS. 7 and 8, that the bodies 144 and 146 are square. That is, the dimension W_{OE} is the same for interior width and interior length of the body 144. Similarly, the dimension W_{IS} is the same for the exterior width and exterior length of the body 146. Where the bodies 144, 146 are not square, for example, are rectangular, it may be appreciated that the length and width of the interior of body 144 may still be larger than the length and width of the exterior of body 146 such that reciprocal, telescoping movement is still permitted between the inner support 116 and the outer extension 118.

Referring now to FIGS. 8A-8E, the inner support 116 is shown. The inner support 116 may have a body 146 with a rectangular or square cross-section, although other shapes are contemplated such as cylindrical (FIGS. 1-4), triangular, polygonal, etc. The body 146 may include a bore 148 having a first bore section 148a and a second bore section 148b. The first bore section 148a may have a larger diameter than the second bore section 148b. The first bore section 148a may extend along a longer length of the inner support 116 than the second bore section 148b. The second bore section 148b may include a threaded surface 150. The threaded surface 150 may interact with the threaded outer surface 134 of the rotation member 124.

With continued reference to FIGS. 8A, 8D, and 8E, the body 146 may include an opening 152 and an opening 154. The opening 152 or opening 154 may accommodate a pin 156. The pin 156 may be inserted through the opening 152 or opening 154 and through a coupling member (similar to 136 of FIG. 6) on the proximal end of the spring 128 (FIG. 6). The pin 156 may be welded or otherwise secured in the opening 152 or the opening 154 such that spring 128 is securely fastened to the inner support 116. The opening 152 or opening 154 may be selected for the pin 156 based on the desired tension of the spring 128 and the desired permitted movement of the inner support 116 within the outer extension 118. The inner support 116 can move or slide longitudinally (e.g., telescope) within the outer extension 118.

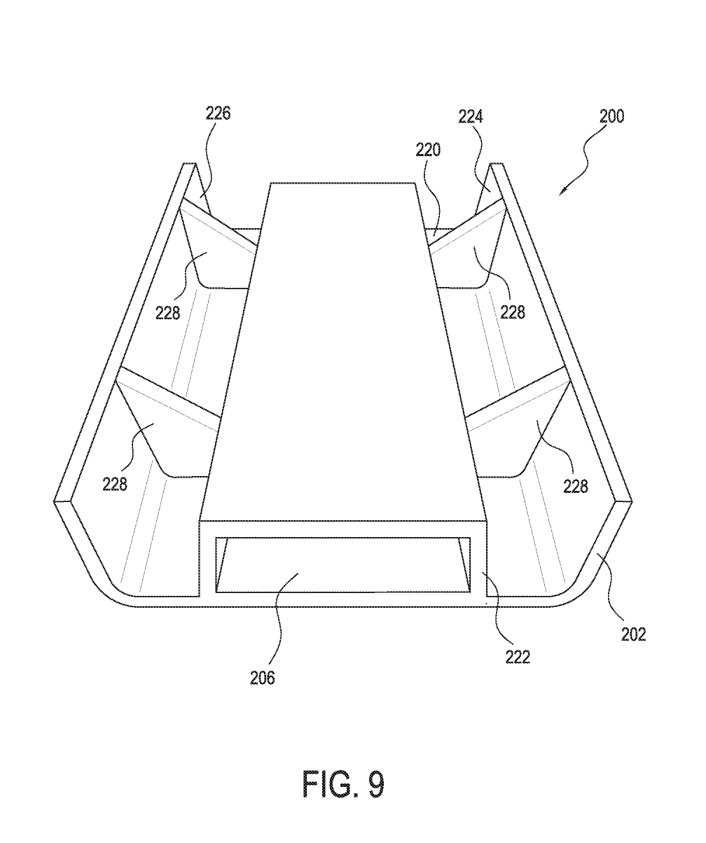

Referring to FIG. 9, an exemplary tire traction device 200 is shown. The tire traction device 200 may include a traction plate 202. The traction plate 202 can include a substantially flat plate portion 220 and a channel 222 that extends upward from the plate portion 220. Alternatively, the channel 202 may extend downward or below the plate portion 220. The channel 222 can be dimensioned to receive expansion strap 12, 112 (FIGS. 1, 5) within an opening 206 of the channel 222. The traction plate 202 can also include one or more traction-enhancing surfaces extending away from the plate portion 220, e.g., upwards. For example, as shown, the traction-enhancing surfaces can include first and second paddles 224, 226 that extend upward from opposed ends of the plate portion 220, e.g., substantially perpendicular thereto. Reinforcement gussets 228 can extend between the plate portion 220 and the paddles 224, 226, for example, to resist the paddles 224, 226 from deflecting with respect to the plate portion 220. The paddles 224, 226 can be formed integrally with the plate portion 220, for example, by bending the plate portion 220 or by extruding the traction plate 202. However, in alternative embodiments, the traction-enhancing surfaces, such as paddles 224, 226 can be separate elements attached to the plate portion 220, for example, through welding, bonding, fasteners, or other techniques known in the art Additional examples of tire traction devices are described in Applicant's U.S. Patent Application Publication No. 2017/0015160, the contents of which are incorporated in their entirety.

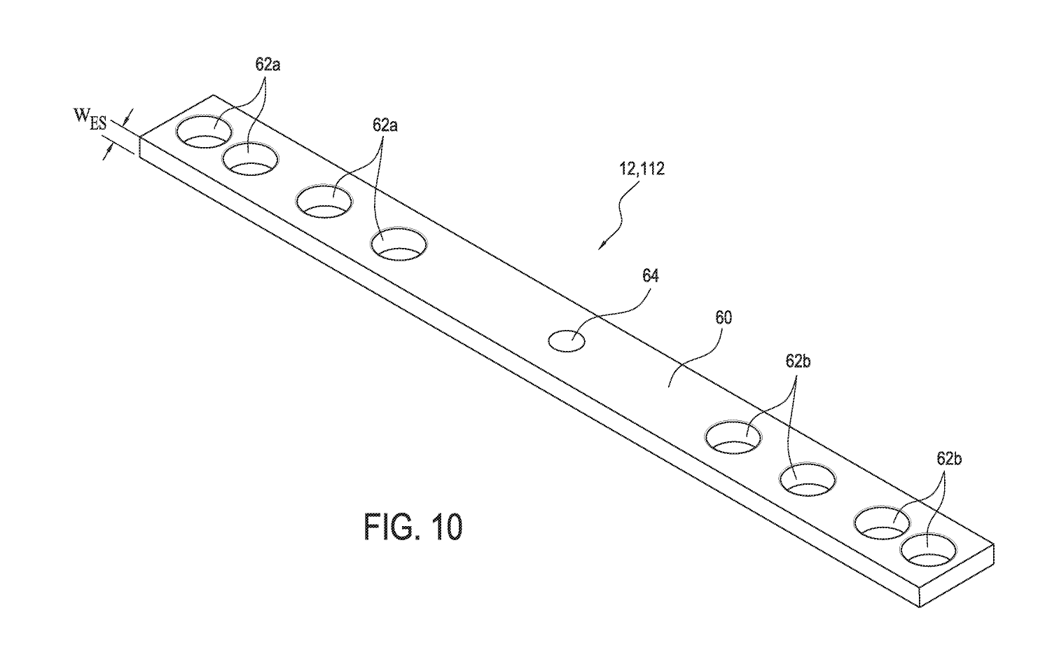

Referring to FIG. 10, a perspective view of the expansion strap 12, 112 is shown. The expansion strap 12, 112 may include a longitudinal body 60 having a plurality of openings 62a, 62b therein. The longitudinal body 60 may extend through the opening 206 of one or more tire traction devices 200 and into the channel 222. For example, where a first device 200a and a second device 200b (FIGS. 1 and 5) are provided, the longitudinal body 60 may extend through an opening 206 in each device and into the corresponding channel 222. One or more of the plurality of openings 62a may be aligned with a corresponding opening(s) (not depicted) of the traction device 200a (FIGS. 1 and 5). One or more of the plurality of openings 62b may be aligned with a corresponding opening(s) of the traction device 200b (FIGS. 1 and 5). Once aligned, the one or more openings 62a, 62b may be fastened, coupled, or otherwise secured to the traction devices 200a, 200b (for example, with a screw). Alternatively, the expansion strap 12, 112 may be welded, bonded, or otherwise secured to the traction devices 200a, 200b.

With continued reference to FIG. 10, the expansion strap 12, 112 may include an opening 64. The opening 64 may be located substantially in the middle of the longitudinal body 60. The opening 64 may be aligned with the opening 30, 130 (FIGS. 2 and 6) of the inner support 16, 116. The rotation member 24, 124 may extend through the opening 64, such that when assembled, the expansion strap 12, 112 and thus the tire traction devices 200a, 200b may be securely fastened to the quick connect tire traction device 10, 100.

Referring to FIGS. 11A-11D the center mount 14, 114 is shown. The center mount 14, 114 may include a body 66 having a substantially triangular portion 66a and a flange 66b. The flange 66b may extend a length LF that is the same as or slightly larger than a width W_{ES} (FIG. 10) of the expansion strap 12, 112. During assembly, the expansion strap 12, 112 may rest on a surface 68 of the triangular portion 66a. The expansion strap 12, 112 may be welded, bonded, or otherwise secured to the flange 66b and the surface 68.

With continued reference to FIGS. 11A-11D, the center mount 14, 114 may include a channel 70. The channel 70 may extend from a surface 72 of the triangular portion 66a to the surface 68 of the triangular portion 66a. The channel 70 may be substantially rectangular or square in shape, as depicted in FIG. 11A. However, the channel 70 may have other shapes, such as semi-circular. It may be appreciated that the channel 70 may have a shape that is complementary to the shape of the inner support 16, 116 such that the inner support 16, 116 may be positioned in the channel. For example, the channel 70 depicted in FIGS. 11A-11D may be placed around the inner support 116. In this manner, the inner support 116 may be allowed to move or slide longitudinally with respect to the channel 70. During assembly, a second center mount 14, 114 may be provided opposing the first center mount 14, 114 such that a central bore (formed by the two channels 70) is formed therethrough. The inner support 16, 116 may extend through the central bore created by the mating channels 70. The two center mounts 14, 114 provided may be welded, bonded or otherwise secured to the expansion strap 12 but may not be otherwise coupled to the inner support 16, 116 such that the inner support 16, 116 is allowed to move within the central bore formed by the mating channels 70.

Referring to FIGS. 12A-12C, the rim mount 20, 120 is shown. As may be appreciated, the rim mount 20 and rim mount 120 may be similar or the same. The rim mount 20, 120 may include openings 80 through which the locking pin 22, 122 may extend. The rim mount 20, 120 may have a body 74 formed as an elliptic cylinder. The openings 80 may extend through the body 74. The openings 80 may include divots, slots, or grooves 76. The grooves 76 may intersect an interior slot 77 form in the interior of the body 74 of the rim mount 20, 120. Each groove 76 and slot 77 may accommodate a locating pin 78, 178 (FIGS. 1, 5) attached to the locking pin 22, 122. The rim mount 20, 120 may have a flat surface 82 onto which the outer extension 18, 118 may be welded, bonded, or otherwise secured.

During installation of the locking pin 22, 122 into the rim mount 20, 120, the locating pin 78, 178 (which is fixedly secured to the locking pin 22, 122) may be aligned with the groove 76. As the locking pin 22, 122 is moved laterally into the rim mount 20, 120, the locating pin 78, 178 may enter the slot 77. To secure the locking pin 22, 122 in the rim mount 20, 120, the locking pin 22, 122 may be rotated such that the locating pin 78, 178 travels radially in the slot 77 away from the groove 76. In this manner, lateral movement of the locking pin 22, 122 into or out of the rim mount 20, 120 is not permitted. Such lateral movement will cause the locating pin 78, 178 to interact with the slides of the slot 77 as the locating pin 78, 178 is no longer aligned with the groove 76 after rotation of the locking pin 22, 122. Thus, it may be appreciated the locking pin 22, 122 is retained win the opening 80 of the rim mount 20, 120 due to the locating pin 78, 178 being located in the slot 77 and out of alignment with the groove 76.

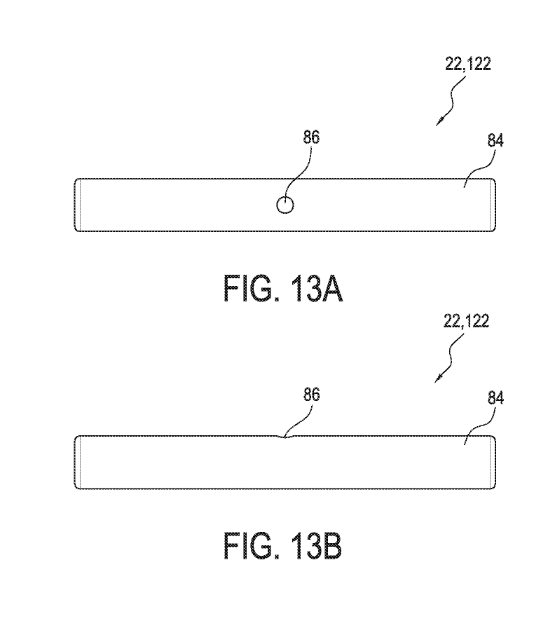

Referring to FIGS. 13A, 13B the locking pin 22, 122 is shown. The locking pin 22, 122 may have a substantially cylindrical body 84. The body 84 may be solid. The body 84 may be other shapes that can be received within the openings 80 in the rim mount 20, 120. The locking pin 22, 122 may include an opening 86 within which the locating pin 78, 178 may be secured.

As may be appreciated the components of the quick connect tire traction device 10, 100 may be formed of any material. For example, metal, steel, aluminum, durable plastic, composites, wear resistant materials, etc. It may be appreciated that the center mount, inner support, outer extension, rim mount, and locking pin may be composed of any of the aforementioned materials or combinations thereof.

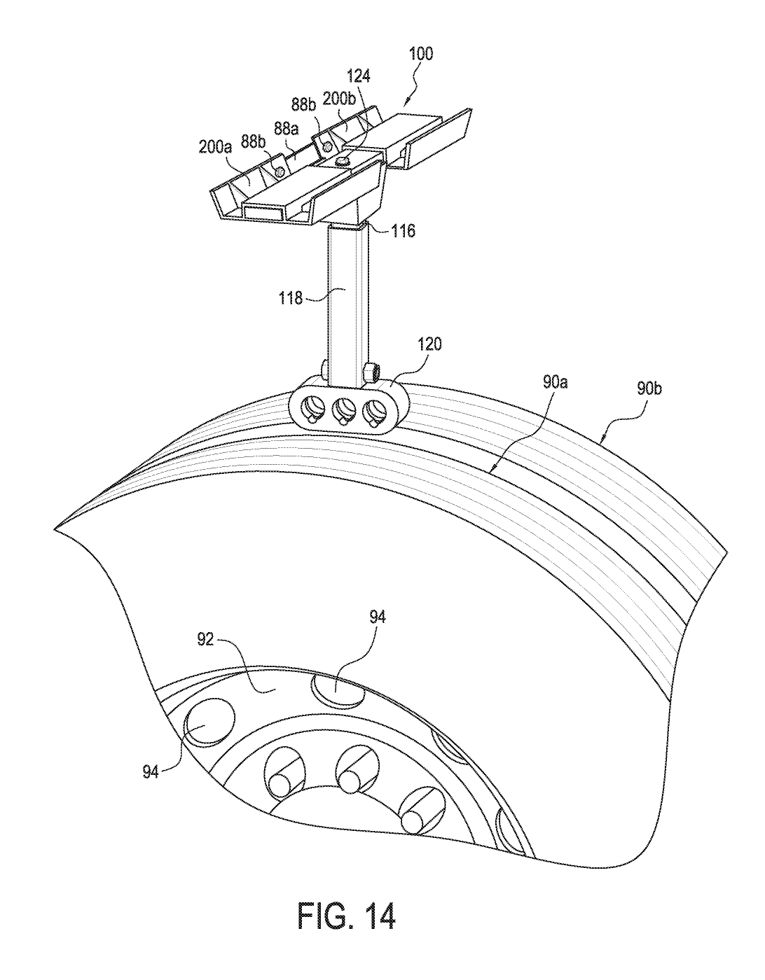

With the quick connect tire traction device 10, 100 described and with reference to FIGS. 14-17, installation and removal of the quick connect tire traction device 10, 100 may now be appreciated. Reference is made to quick connect tire traction device 100 and associated components during the description of installation and removal, however, quick connect tire traction device 10 may be installed and removed in the same or similar manner. FIG. 14 depicts an extension strap 88a secured to the tire traction devices 200a, 200b with fasteners 88b. The extension strap 88a may be used in addition to the expansion strap 112 to provide additionally stability, support, and alignment to the tire traction devices 200a, 200b. However, according to embodiments, the extension strap 88a and fasteners 88b may be omitted.

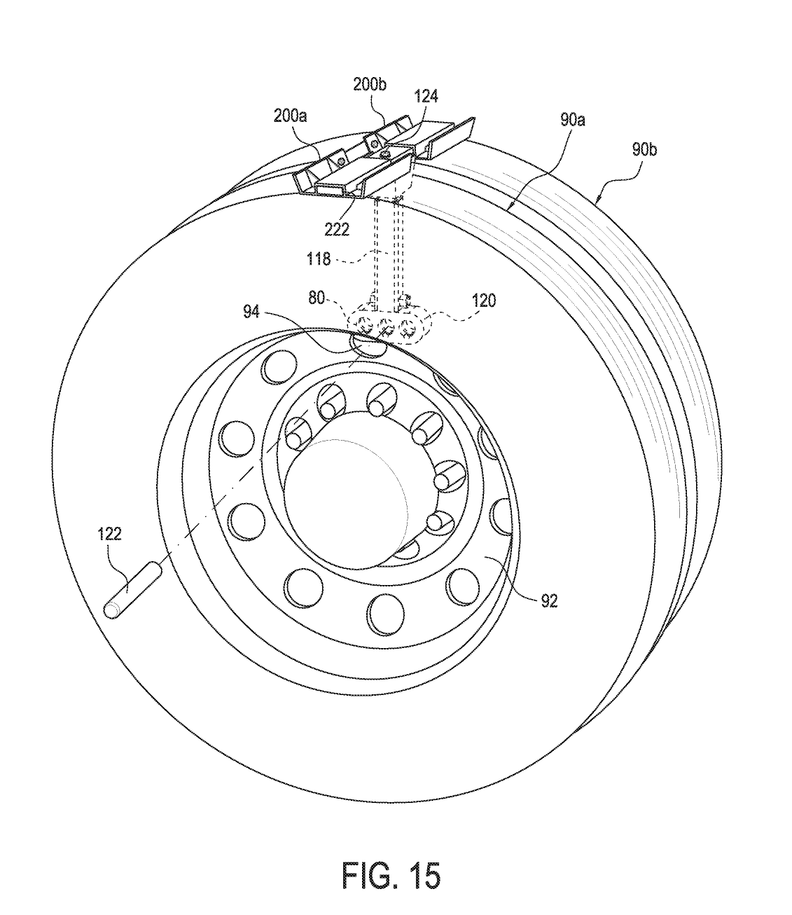

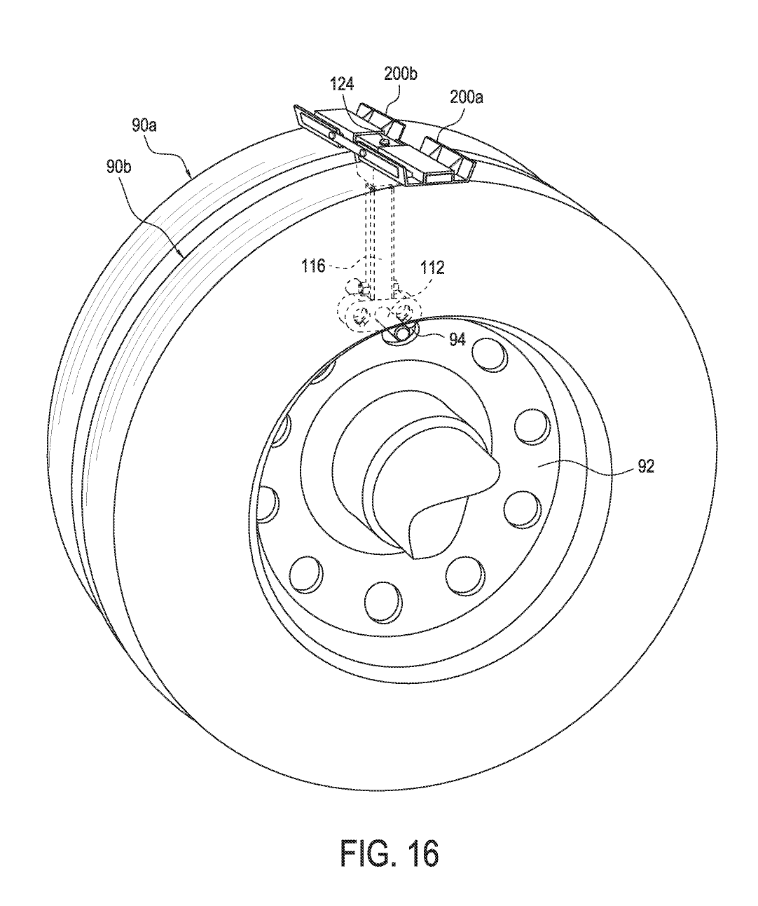

Referring first to FIG. 14, the quick connect tire traction device 100 may be lowered into a space between the tires 90a, 90b of a dual-tire wheel. The width of the rim mount 120 and outer extension 118 is such that the components may fit in the space. Referring now to FIG. 15 (which shows the tire 90a in the foreground), the quick connect tire traction device 100 may be lowered until the openings 80 of the rim mount 120 are aligned with an opening 94 on a rim 92 to which tire 90a is mounted. In this position a lower surface of the channel 222 of the tire traction devices 200a, 200b may rest on the outer surface of the tires 90a, 90b. After the quick connect tire traction device 100 is properly aligned, the locking pin 122 may be inserted into the opening 94 in rim 92, through the opening 80 in rim mount 120, and through a corresponding opening 94 on a second rim supporting tire 90b (shown best in FIG. 16). The locking pin 122 may be inserted into the opening 80 of the rim mount 120 by aligning the locating pin 178 with the groove 76 (FIGS. 12A-12C). The locking pin 122 may be inserted into the rim mount 120 until the locating pin 178 meets the rear wall of the groove 76 (e.g. enters the slot 77). At this point, the locking pin 122 may be rotated clockwise or counterclockwise. The rotation of the locking pin 122 moves the locating pin 178 radially in the slot 77 such that the locking pin 122 is retained securely in the rim mount. The locking pin 122 extends between the aligned openings 94 in the front and rear rims 92, and holds the quick connect tire traction device 100 in place. Although a single locking pin 122 is described, it may be appreciated that more than one locking pin 122 may be inserted into the rim mount 120 through the remaining openings 80.

As will be appreciated, at this stage, the quick connect tire traction device 100 is properly aligned and coupled to the tires 90a, 90b. However, the quick connect tire traction device 100 is not yet firmly secured to the tires 90a, 90b. As will be appreciated, with just the locking pin 122 in place, the quick connect tire traction device 100 may be rotated slightly along the tires 90a, 90b with the locking pin 122 as a pivot point. To firmly secure the quick connect tire traction device 100 to the tires 90a, 90b, a tool can be used to rotate the rotation member 124. When the rotation member 124 is a fastener having a hexagonal head, the tool may be a hexagonal socket wrench. When the rotation member 124 takes other shapes, the tool may be any socket, wrench, or tool which has a complementary shape for rotating the rotation member 124.

With reference to FIGS. 6, 8, and 15, as the socket wrench rotates the rotation member 124, the threaded surface 134 of the rotation member 124 advances into the threaded surface 150 of the bore 148b of the inner support 116 (FIG. 8D), drawing the inner support 116 closer to the expansion member 112. The expansion member 112 is resting on the outer surface of the tires 90a, 90b (via the tire traction devices 200a, 200b), and the locking pin 122 is securing the rim mount 120 to the rims 92. The inner rim support 116 and the outer extension 118 are coupled together by the spring 128. Accordingly, continued tightening of the rotation member draws the inner support 116 away from the outer extension 118, stretching the spring 128, in turn compressing the expansion member 112 and associated tire traction devices 200a, 200b against the outer surface of the tires 90a, 90b. When the rotation member 24 can no longer be rotated due to the increased opposing force, or when the desired securement of the quick connect tire traction device 100 is reached, the socket wrench may be removed.

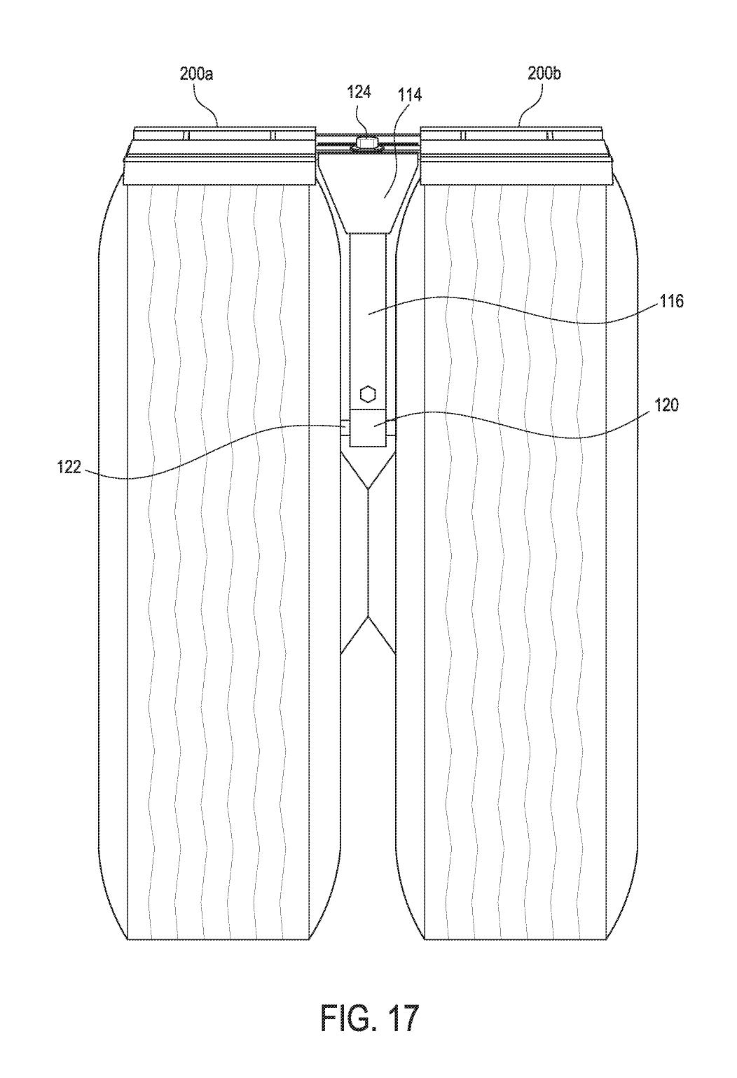

With reference to FIG. 16 (which shows the rear side of the wheel of FIG. 15 such that tire 90b is now in the foreground), the quick connect tire traction device 100 is depicted in a fully installed position. In the position of FIG. 16, the locking pin 122 and the expansion strap 112 are forced toward each other under the force of spring 128, holding the tire traction devices 200a, 200b securely in place on the tires 90a, 90b. FIG. 17 depicts a side view of the tires 90A, 90b with the quick connect tire traction device 100 installed. From this view it may be appreciated that the locking pin 122 extends into the openings 94 (not depicted) on the rims 92 of each of the tires 90a, 90b.

With reference to FIGS. 14-17, to remove the quick connect tire traction device 100, the tool may be used to rotate the rotation member 124 in the opposite direction of the securing rotation, thus relieving the tension on the spring 128. The rotation member 124 may be completely removed or may be loosened until the locking pin 122 is loose enough to be removed from the opening 94. After rotation member 124 has been loosened, the locking pin 122 may be rotated clockwise or counterclockwise in a direction opposite of rotation during installation until the locating pin 178 aligns with the groove 76. When the locating pin 178 is aligned with the groove 76, the locking pin may be moved laterally out of the rim mount 120. The locking pin 122 may be removed and the quick connect tire traction device 100 may be lifted upward to remove it from the space between the tires 94a, 94b. From the foregoing disclosure it may be appreciated that the quick connect tire traction device 10, 100 allows for the quick installation and removal of tire traction devices 200a, 200b in the event such tire traction is needed quickly and/or easily.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A quick connect tire traction system for providing traction to a tire on a vehicle wheel, the quick connect tire traction system comprising:
an expansion strap coupled to one or more tire traction devices;
an inner support coupled to the expansion strap with a rotation member;
an outer extension telescopically coupled to the inner support;
a rim mount coupled to the outer extension, the rim mount configured to receive one or more locking pins; and
an elastic element extending between the inner support and the outer extension,
wherein the elastic element is adapted to bias the tire traction devices toward the rim mount thereby securing the quick connect tire traction system to the tire.

2. The quick connect tire traction system of claim 1, further comprising a center mount, the center mount secured to the expansion strap and mounted around the inner support.

3. The quick connect tire traction system of claim 1, wherein the rotation member is a hexagonal head fastener.

4. The quick connect tire traction system of claim 1, wherein the inner support is located within the outer extension.

5. The quick connect tire traction system of claim 4, wherein the inner support has a cross-section of the same shape as the cross-section of the outer extension.

6. The quick connect tire traction system of claim 5, wherein the cross-section is one of circular, rectangular, or square.

7. The quick connect tire traction system of claim 1, wherein the inner support is a hollow, cylindrical member and the outer extension is a hollow, cylindrical member.

8. The quick connect tire traction system of claim 1, wherein the inner support is a hollow member with a square or rectangular cross-section and wherein the outer extension is a hollow member with a square or rectangular cross-section.

9. The quick connect tire traction system of claim 1, wherein the one or more locking pins are configured to extend through one or more openings on a rim of the vehicle wheel.

10. The quick connect tire traction system of claim 1, wherein in an installed position, the one or more tire traction devices and the rim mount are biased toward one another via the elastic element.

11. The quick connect tire traction system of claim 1, wherein the inner support further comprises a rod extending horizontally therethrough and a proximal end of the elastic element coupled to the rod.

12. The quick connect tire traction system of claim 11, wherein the outer extension further comprises a fastener extending horizontal therethrough and a distal end of the elastic element coupled to the fastener.

13. The quick connect tire traction system of claim 12, wherein rotation of the rotation member extends the elastic element.

14. A method for installing a tire traction device on a tire of a vehicle wheel, the method comprising:
coupling an expansion strap to one or more tire traction devices;
inserting a rim mount into a space between a first tire and a second tire, the
rim mount coupled to the expansion strap by an elastic member;
resting a lower surface of the one or more tire traction devices on an exterior surface of the first and second tires;
extending a locking pin through an opening in a first rim mounting the first tire, through an opening in the rim mount, and through an opening in a second rim mounting the second tire; and
extending the elastic member to secure the one or more tire traction devices to the first tire and the second tire.

15. The method of claim 14, wherein coupling an expansion strap to one or more tire traction devices comprises coupling with a plurality of fasteners extending through corresponding openings on the expansion strap and the one or more tire traction devices.

16. The method of claim 14, wherein extending the elastic member comprises tightening a threaded rotation member joining the expansion strap to an inner support.

17. The method of claim 16, wherein tightening the threaded rotation member advances the inner support toward and outer extension, the outer extension connected to the rim mount.
